(19) United States
(12) Patent Application Publication
(10) Pub. No.: US 2010/0174826 A1
(43) Pub. Date: Jul. 8, 2010

(54) Information gathering system and method

(76) Inventors: Anupam Sharma, Union City, NJ (US); Devendra Patole, Pune (IN); Abhimanyu Sharma, Haryana (IN)

Correspondence Address: PATENT DOCKET ADMINISTRATOR;LOWENSTEIN SANDLER PC, 65 LIVINGSTON AVENUE, ROSELAND, NJ, 07068, US

(21) Appl. No.: 11/020,290

(22) Filed: Dec. 23, 2004

Related U.S. Application Data
(60) Provisional application No. 60/532,295, filed on Dec. 23, 2003.

(51) Int. Cl. G06F 15/16; H04L 9/32

(52) U.S. Cl. 709/235; 713/175

(57) ABSTRACT

A system and a method for gathering information in a secure and efficient manner is provided. A two-level security procedure ensures that communication occurs only between authorized parties. Communications between parties are according to the XML convention, which enables the parties to communicate or transfer information with each other even if they use incompatible communications systems. Communications may occur synchronously or asynchronously depending on predetermined parameters, such as the complexity of the communication and the amount of information being communicated or transferred.

### CROSS REFERENCE TO RELATED APPLICATIONS

This application claims benefit of Provisional Application No. 60/532,295, filed Dec. 23, 2003, the entire disclosure of which is incorporated herein by reference.

### BACKGROUND OF THE INVENTION

1. Field of the Invention

The present invention relates generally to a technique for enabling secure communications between two or more parties. More specifically, the present invention relates to an information gathering system and method, in which asynchronous or synchronous communications between parties take place via a secure interface.

2. Related Art

At times, a company needs to communicate with an external party to exchange information so that the external party may further process the exchanged information. The external party is, for example, a party that operates independently of the company and thus does not share common databases and communication schemes with the company. For example, a financial institution may need to work with a trusted external aggregator, which aggregates financial information for the financial institution for further processing. The financial institution grants, to the trusted external aggregator, access to its Web sites (collection of Web pages) so that the external aggregator may gather the necessary information for processing. A difficulty that often occurs in such an arrangement is that the company and the external party utilize incompatible communications systems, which makes the exchange of information inefficient and which also presents security concerns because the information cannot be directly transferred.

One conventional scheme that enables information to be transferred between parties or users with incompatible communications systems utilizes “scripts.” A script is a software application that enables a user to log on to another party's Web site using a specific user name and password combination. When an appropriate user name and password combination is inputted, the script links the user to a Web page in the other party's Web site, where the user then may access the information on that Web page. Conventionally, the user then uses an image capture technique, such as a so-called “screen scrape” technique or any other known technique for capturing information from an image displayed on a computer screen. In the conventional screen-scrape technique, a software application extracts information that is displayed at one or more specific locations on the computer screen. If information is to be extracted from multiple Web pages, the script must be run for each Web page. Once the screen scrapes have been completed for the multiple Web pages, the user then sorts them and compiles the extracted information into relevant data sets.

The conventional screen-scraping technique suffers from a number of deficiencies. First, the technique requires a script to be run repetitively for multiple Web pages of similar format or layout. Therefore, similarly formatted Web pages must still be distinctly identified for a particular script. Second, different scripts must be run for Web pages with different formats, because the location of the information to be extracted is different for the differently formatted Web pages. Therefore, in addition to running the same script repeatedly for Web pages of the same format, a separate script must be run for each Web page with a different format. Third, every time the format of a Web page changes, the image-processing algorithm for the script corresponding to that Web page must be modified.

The complexity of the conventional screen-scraping technique can easily escalate, making the technique cumbersome to administer and prone to errors caused by updates to Web-page formats of a large number of Web pages. More specifically, because Web sites often include hundreds, if not thousands of Web pages, the frequency at which at least some of the Web-page formats are changed can be high, which makes the conventional screen scraping technique time-consuming and costly to administer. Further, in the case of information maintained by companies such as financial corporations, not only is the conventional screen-scraping technique inefficient, an error in the extraction of information can result in a significant monetary accounting error.

Accordingly, there is a need for a simple way for parties to securely communicate or transfer information with each other, so that information may be gathered efficiently and securely even among parties with incompatible communications systems.

### SUMMARY OF INVENTION

The present invention provides a system and a method for gathering information in a secure and efficient manner. According to the invention, a security procedure is used to ensure that communication occurs only between authorized parties. Additionally, an XML (Extensible Markup Language) interface is used for communication, which enables parties with incompatible communications systems to easily transfer information with each other. Further, communications may occur synchronously or asynchronously depending on their complexity and the amount of information being communicated or transferred.

According to an aspect of the present invention, the security procedure is a secure handshake that includes at least two layers of security. In the first layer, a first party verifies a second party's authority to access the first party's information system by use of a digital certificate or digital ID, which identifies the second party. In the second layer, the first party obtains a user name and a password from the second party, and verifies whether the second party is permitted access to the desired information based on the user name and the password.

According to another aspect of the present invention, after it is verified that the second party is permitted access to the desired information, requests for the desired information are mapped to appropriate actions to be taken by the system. The requests may be throttled to prevent excessive load on the system. An asynchronous message-oriented architecture of the system supports both batch and real-time processing. Batch requests are routed to a queue and usually, although not necessarily, are processed asynchronously. Requests involving real-time processing may be routed to an interactive component of the system, such as a Java session bean, for real-time or synchronous processing. The system makes a determination as to whether the information is to be transferred synchronously or asynchronously based on predetermined criteria. For simple communications in which the quantity of information to be transferred is less than a predetermined amount, the information is transferred synchronously or in real time. For complex communications in which the quantity of information to be transferred is greater than the predetermined amount, the information is transferred asynchronously via a proxy server.

According to a further aspect of the present invention, the system has the flexibility to accommodate new subsystems through use of new adaptors, each of which, for example, encapsulates a business workflow for obtaining data. Adaptors also may be used to provide other functions such as transaction management functions, for example.

### BRIEF DESCRIPTION OF THE DRAWINGS

The features and advantages of the present invention will be apparent from the description of the preferred embodiment(s) presented below considered in conjunction with the attached figures, of which:

FIG. 1 is a schematic illustration of an information gathering system, according to an embodiment of the present invention.

FIG. 2 is a flow chart illustrating a process flow for handling requests, according to an embodiment of the present invention.

FIG. 3 is a diagram showing the flow of information, according to an embodiment of the present invention.

FIG. 4 is a diagram showing the flow of information in a request/response cycle, according to an embodiment of the present invention.

FIG. 5 is a diagram showing the flow of information, according to an embodiment of the present invention.

### DETAILED DESCRIPTION OF THE PREFERRED EMBODIMENT(S)

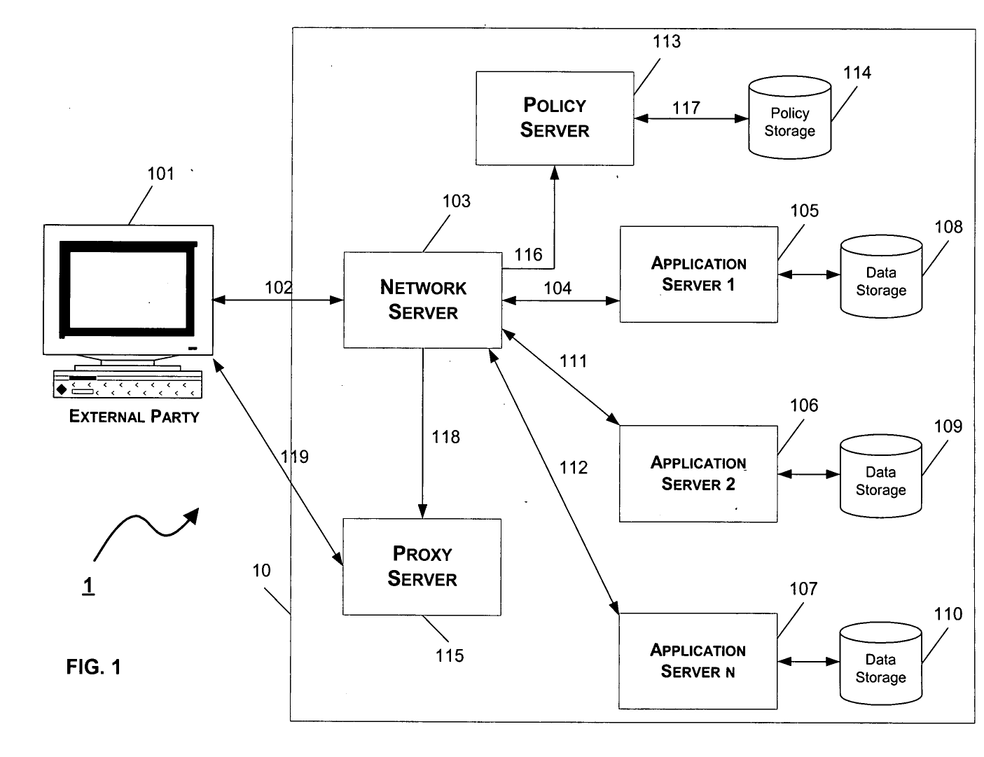

FIG. 1 schematically illustrates an information gathering system 1 according to an embodiment of the present invention. In FIG. 1, an external party 101 is in communication with a network server 103 of a company system 10 via a communication link 102. Preferably, the communication link 102 utilizes a global communications network such as the Internet, and preferably the network server 103 is a Web server. According to a preferred embodiment, the company system 10 belongs to a financial institution, and the external party 101 is an external aggregator.

The external party 101 includes any type of computing device with the ability to communicate with a server, including but not limited to a personal computer, a personal digital assistant, a workstation, a mainframe computer, and the like. Additionally, the external party 101 may be located on-site with the company system 10 or off-site at a remote location, including a foreign country, as long as communication between the external party 101 and the company system 10 is possible.

The network server 103 includes a controller (not shown), which is programmed to perform a traffic-control function to control the amount of traffic or load that the external party 101 makes on the company system 10. That is, the controller is configured to throttle the amount of traffic to prevent the external party 101 from putting an excessive load on the company system 10.

The controller provides incoming requests for information from the external party 101 to a request handler (not shown) of the network server 103. The request handler is programmed to map or distribute the incoming requests for information to at least one application server 105, 106, 107 via a respective communication link 104, 111, 112. According to a preferred embodiment, the request handler is configured to handle requests for information of various XML message formats. Optionally, the request handler is configured to package user information into Java objects. For example, the request handler creates one Java object per user.

A data storage unit 108, 109, 110, is associated with each application server 105, 106, 107, and is used to store data corresponding to the respective applications of the application servers 105, 106, 107. Each application server 105, 106, 107 functions to handle data processing operations for a business unit of the financial institution.

A policy server 113 is in communication with the network server 103 via a communication link 116. The policy server 113 has an associated policy storage unit 114, which is in communication with the policy server 113 via a communication link 117. The policy server 113 functions to implement the financial company's policy relating to secure communications with the external party 101.

A proxy server 115 is in communication with the network server 103 via a communication link 118. The proxy server 115 also is in communication with the external party 101 via a communication link 119. The proxy server 115 functions to save asynchronously transferred responses for later retrieval by the external party 101.

The communication links 102, 104, 111, 112, 116, 119 may utilize a global communications network such as the internet, an intranet, or any other known means of communication between servers, including wired and wireless means. Similarly, the communication link 117 may utilize any known means of communication between a server and a storage unit, including wired and wireless means.

Although FIG. 1 shows the network server 103, the application servers 105, 106, 107, the data storage units 108, 109, 110, the proxy server 115, the policy server 113, and the policy storage unit 114 as distinct and separate units, one skilled in the art will appreciate that these units of the company system 10 may be integrated into a single composite system in which a single server includes operational software routines corresponding to the application servers 105, 106, 107, the policy server 113, and the proxy server 115, and in which a single memory device includes memory portions corresponding to the policy storage unit 114 and the data storage units 108, 109, 110.

According to a preferred embodiment, the external party 101 is an external aggregator that is permitted limited access to confidential information stored in one or more of the data storage units 108, 109, 110 of the company system 10. That is, information is transferred from the data storage units 108, 109, 110 via a security procedure, as discussed below.

The following is an example of a request/response communication cycle between a financial institution and an external aggregator, according to an embodiment of the present invention, in which the external aggregator corresponds to the external party 101, and in which the company system 10 belongs to the financial institution.

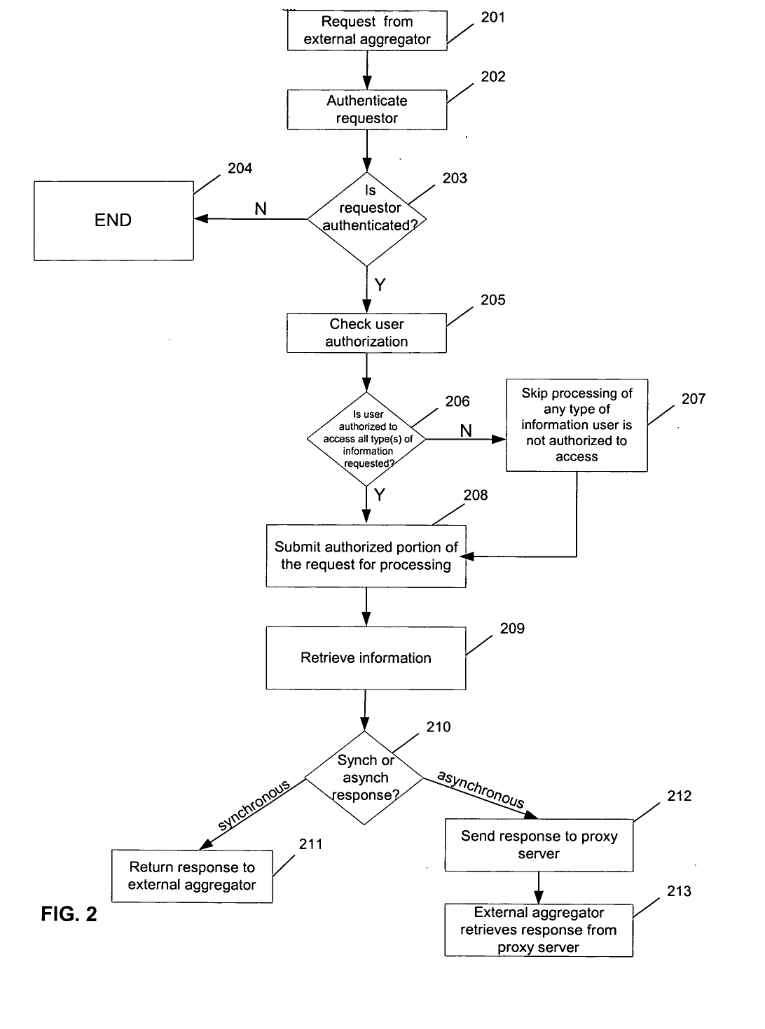

As shown in FIGS. 1 and 2, a request is sent by a user from the external aggregator 101 to the network server 103 via the communication link 102 (step 201). For example, the request may be for financial information on a particular individual or on a group of individuals. The request is authenticated by the network server 103 to verify whether an exchange of information is permitted (step 202). Preferably, authentication involves the network server 103 receiving from the external aggregator 101 a digital certificate, which identifies the external aggregator 101 to the network server 103. The network server 103 sends the digital certificate to the policy server 113, which utilizes information stored in the policy storage unit 114 to determine whether the external aggregator 101 is a valid (authorized) requestor (step 203). If the external aggregator is not authorized, processing stops (step 204). Once the external aggregator 101 is authenticated as a valid requestor, an optional second security check may be implemented (step 205).

In the second security check, it is determined whether the type of information requested is a type that the user is authorized to access. This involves obtaining from the user, via the external aggregator 101, the user's user name and associated password (also referred to herein as “credentials”) for the requested information. If more than one type of information is requested, the user must provide credentials for each type of requested information. The credentials are forwarded from the network server 103 to the policy server 113, which verifies whether the user is permitted to access the type of information requested.

The second security check ensures not only that the external aggregator 101 is authorized to exchange information with the financial institution, it also verifies whether the user is permitted to access the specific type of information requested (step 206). If the external aggregator is not authorized to access one or more of the types of information, processing of the request does not terminate. Rather, only processing of the unauthorized type of information ends (step 207). Processing continues for the types of information the user is authorized to access (step 208).

The security procedures discussed above may be adapted or modified to function with authentication techniques known in the art, such as Single Sign On (SSO) techniques, for example. However, while conventional uses of SSO techniques usually require a SSO session for each individual user, which necessitates a large amount of system resources, the security procedures of the present invention utilize a single authentication process for authenticating the external party 101. Once the external party 101 is authenticated, credentials are verified for each individual user of the external party 101 or for each type of information requested in the request, by comparing the credentials with the information stored in the policy storage unit 114, as discussed in more detail below. By utilizing a two-tier security procedure, which requires only one authentication process for the external party 101, such as one SSO session, for example, the amount of system resources required to ensure security of communications with the external party 101 is reduced.

In step 208, the authorized portion of the request is passed to one or more of the application servers 105, 106, 107 via the communication links 104, 111, 112, depending on the type(s) of information requested. In this example, the requested information is handled by the application server 105. After the application server 105 receives the authorized portion of the request from the network server 103, the application server 105 determines what information to send to the external aggregator 101 and retrieves the appropriate information from the database 108 (step 209). The application server 105 then sends the retrieved information to the network server 103 via the communication link 104, and the network server 103 then sends a response to the external aggregator 101.

The response is sent synchronously or asynchronously (step 209). If the response is a simple one and the amount of information to be sent to the external aggregator 101 is less than a predetermined amount, the response is sent synchronously from the network server 103 to the external aggregator 101 via the communication link 102 (step 211). If the response is a complicated one or if the amount of information to be sent to the external aggregator 101 is greater than the predetermined amount, the response is sent asynchronously. That is, for a complex communication or one in which a large amount of information is to be transferred, the information is sent to the external party 101 via the communication link 119 from the network server 103. If the external party 101 is outside a security firewall of the financial institution, the response is sent through the proxy server 115 (step 212).

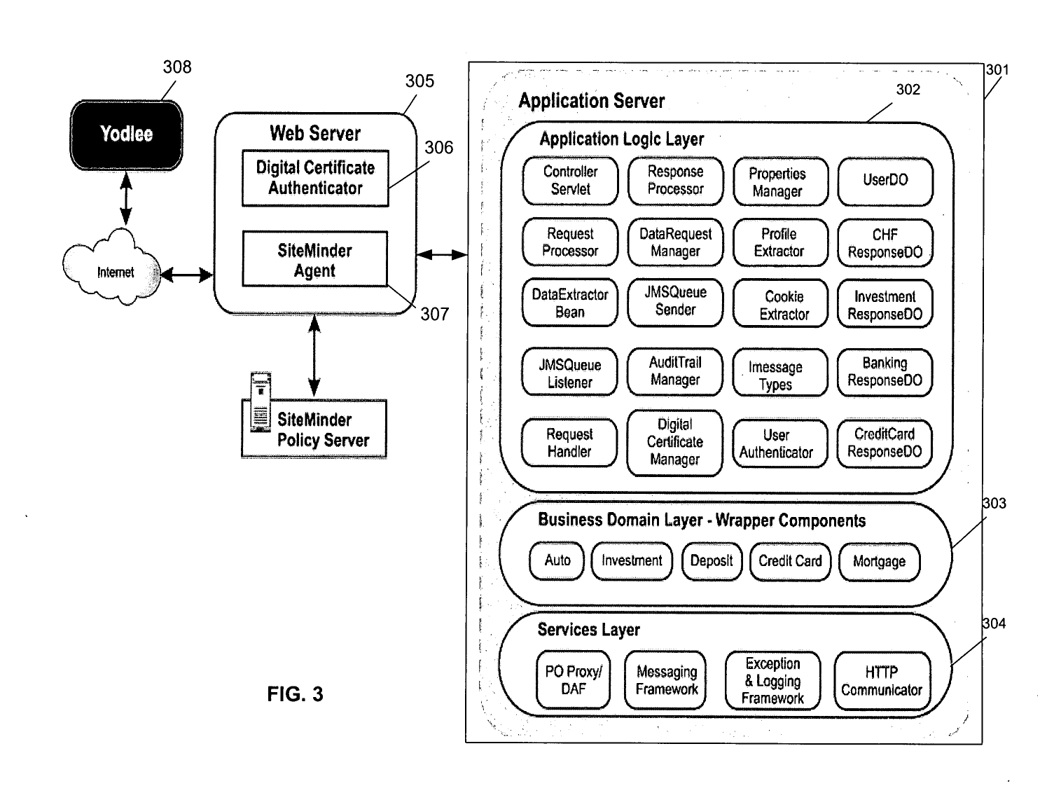

According to another embodiment of the present invention, shown in FIG. 3, an application server 301 is comprised of an application logic layer 302, a business domain layer 303, and a services layer 304. The application logic layer 302 includes modules for performing one or more of the following functions: Controller Servlet, Response Processor, Properties Manager, UserDo, Request Processor, DataRequest Manager, Profile Extractor, CHF ResponseDo, DataExtractor Bean, JMSQueue Sender, Cookie Extractor, Investment ResponseDo, JMSQueue Listener, AuditTrail Manager, Imessage Types, Banking ResponseDO, Request Handler, Digital Certificate Manager, User Authenticator, and CreditCard ResponseDO. As will be appreciated by one of ordinary skill in the art, the functions listed above are exemplary and the application logic layer 302 may include modules for performing other functions.

The JMS (Java Messaging Service) functions enable distributed communication that is loosely coupled, reliable, and asynchronous. The ResponseDO (Reponse Data Objects) functions encapsulate information retrieved from the different lines of business (e.g., Banking, Credit Card, Investment, Home Finance, etc.) associated with the application server 301.

The business domain layer 303 includes modules for one or more of the following financial services categories: auto, investment, deposit, credit card, and mortgage. As will be appreciated by one of ordinary skill in the art, the financial services categories listed above are exemplary and the business domain layer 302 may include modules for other financial services categories.

The services layer 304 includes modules for services such as PO Proxy/DAF, Messaging Framework, Exception and Logging Framework, and HTTP Communicator. The DAF (Data Access Framework) is a framework used for retrieving information from a relational database management system. The Exception and Logging Framework is a robust framework that allows for handling of exception messages and logging messages of different levels for any new component that might be added to the framework in the future. The Messaging Framework may be used for communicating in both synchronous and asynchronous modes with systems in the various lines of business within the financial or other institution to which the application server 301 belongs. The systems may be “legacy” systems originally belonging to the lines of business or they may be Web-based systems of the institution. The HTTP Communicator is a component that enables communication with information sources over the Internet using the HyperText Transfer Protocol (HTTP).

The application server 301 is in communication with a Web server 305, which, similar to the network server 103 of FIG. 1, performs security processing via a digital certificate authenticator 306 for performing a first security procedure and a so-called SiteMinder agent 307 for performing a second security procedure, as discussed above. The Web server 305 is in communication with an external party such as a Yodlee unit 308, for example.

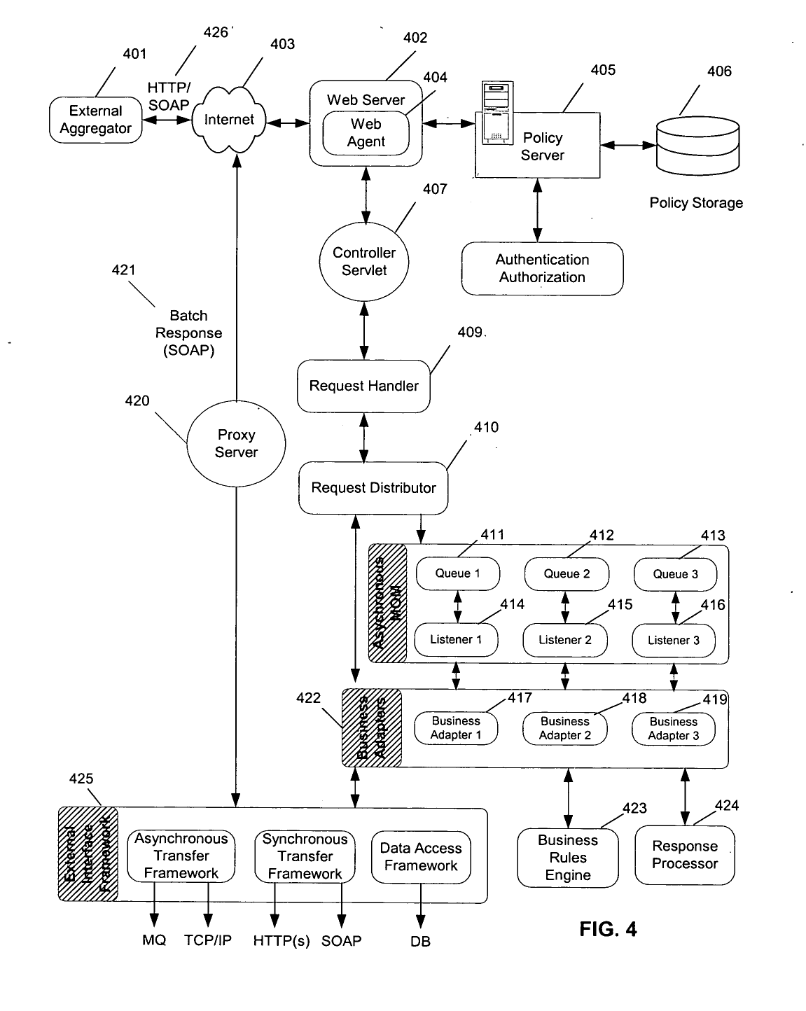

FIG. 4 is another diagram for understanding the flow of information in a request/response communication cycle between a financial institution and an external aggregator, as in the above example, according to an embodiment of the present invention.

As shown in FIG. 4, a Request is sent from an external aggregator 401 by a user seeking information from a financial institution. For example, the user may be a credit agent seeking credit information from the financial institution regarding a particular individual. The Request is sent via the Internet 403 to a Web server 402 of the financial institution using SOAP (Simple Object Access Protocol) procedures 426, which are independent of any operating system or protocol and may be transported using a variety of Internet protocols, including the HTTP, or using HTTP-related procedures such HyperText Transfer Protocol, Secure (HTTPS), for example. The Web server 402 implements an authentication process to determine whether the external aggregator 301 is a valid requestor. To do so, the Web server 402 obtains a digital certificate from the external aggregator 401 via the Internet 403. A Web agent 404 of the Web server 402 verifies from the digital certificate, which identifies the external aggregator 401, whether the external aggregator 401 is allowed to access information from the financial institution. More specifically, the Web agent 404 causes a policy server 405 to utilize information stored in a policy storage unit 406 to perform a verification of the digital certificate. If the digital certificate is verified as belonging to a machine authorized to access information from the financial institution, a connection is established between the external aggregator 401 and the financial institution.

The connection between the external aggregator 401 and the financial institution is an interface that adheres to the XML convention, which utilizes customized tags to enable communication of information between organizations with incompatible communications systems. As is known to one of ordinary skill in the art, XML is based on SGML (Standard Generalized Markup Language), which is a system for organizing and tagging elements of a document. SGML does not specify a particular format for the document, but instead specifies rules for tagging elements of the document.

After it has been verified that the external aggregator 401 is authorized to access information from the financial institution, the external aggregator 401 then submits to the Web server 402 an XML document (the Request) with one or more requests for desired information.

A controller servlet 407, which is a software or firmware application of the Web server 402, extracts credential information from the XML document. Optionally the controller servlet 407 may reside in an external processor working in conjunction with the Web server 402. Credential information includes, for example, a user name and an associated password for each item of information requested. Once the credential information is obtained, the controller servlet 407 sends the credential information to an authentication server 408 for verification that the requested items of information may be released to the external aggregator 401, based on the user name and the associated password provided by the external aggregator 401 for each item of information. The authentication server 408 interacts with a policy server 405, which stores policy information in a policy storage unit 406, to authenticate the credential information, i.e., to verify that the credential information for each of the requested items of information is valid and proper.

The controller servlet 407 also functions to map or distribute the incoming requests for information to a request distributor 410 via a request handler 409, which is a software or firmware application of the Web server 402. Optionally, the request handler 409 may reside in an external processor working in conjunction with the Web server 402. According to a preferred embodiment, the request handler 409 is configured to handle requests for information of various XML message formats. Optionally, the request handler 409 is configured to package user information into Java objects. For example, the request handler 409 may be configured to create one Java object per user.

The XML document from the external aggregator 401 is forwarded to the request handler 409. For each of the requested items of information that have been validated, the request handler 409 identifies the requested information and determines where the requested information is located (stored). For example, referring to FIG. 1, credit card information may be stored in the data storage unit 108 corresponding to the application server 105, mortgage information may be stored in the data storage unit 109 corresponding to the application server 106, and auto finance information may be stored in the storage unit 110 corresponding to the application server 107. The request handler 409 then sends the XML document, or one or more relevant portion(s) thereof, to the appropriate application server(s) via the request distributor 410.

The request distributor 410 is a software or firmware application of the Web server 402, and functions to determine whether the requested items of information are to be handled synchronously or asynchronously. Optionally, the request distributor 409 may reside in an external processor working in conjunction with the Web server 402. The request distributor 409 makes a determination based on predefined rules. The predefined rules may specify that requests for ten or fewer items of information are to be handled synchronously (in real time) through use of a session bean, for example. Otherwise, the predefined rules may specify that requests are to be handled asynchronously (in batch mode). Alternatively, the predefined rules may specify that requests for information amounting to, for example, 1 Mb of data or less will be handled synchronously; otherwise, the requests are to be handled asynchronously.

For a Request that is to be handled in batch mode or asynchronously, i.e., for a large or complex Request, each individual request is put in a processing queue 411, 412, 413. For example, as shown in FIG. 4, if a request pertains to credit-card information, it is sent to queue 1 411; if a request pertains to auto financing, it is sent to queue 2 412, and if a request pertains to mortgage information, it is sent to queue 3 at 413. A listener 1 at 414 monitors the queue 1 411 for new requests; a listener 2 at 415 monitors the queue 2 412 for new requests; and a listener 3 416 monitors the queue 3 413 for new requests.

Upon receipt of an XML request from the listener 1 414 (the XML request being based on the XML document), a business adapter 1 417 translates the XML request into a format suitable to be processed by a particular application server handling the request. For example, an XML request for credit-card information may be converted by the business adapter 1 417 into a SQL (structured query language) format suitable to be processed by an application server handling credit-card information. The business adapter 1 417 is part of a business adapters module 422. Each business adapter 417, 418, 419 functions to encapsulate a workflow procedure for obtaining data or information from a corresponding subsystem or line of business of the financial institution.

Optionally, the business adapters module 422 may be configured to provide flexibility to the system shown in FIG. 4 by accommodating business new adapters corresponding to new subsystems or lines of business of the financial institution. That is, a new line of business or a new subsystem may be added by adding a corresponding new business adapter to the business adapters module 422. In addition to subsystems and lines of business, the business adapters module 422 may accommodate business adapters corresponding to transaction management, concurrency, security, and isolation, etc.

For a Request that is to be handled in real time or synchronously, i.e., for a small or simple Request, the request distributor 410 sends the Request directly to the business adapters module 422 for processing in real time. For example, the Request may be routed to an appropriate business adapter via a Java session bean. Processing then proceeds as described above.

A business rules engine 423 provides appropriate rules for handling the XML requests. For example, if a particular user account has been suspended and the financial institution does not want the requested information accessed, the business rules engine 423 would disallow that XML request from being processed. The business rules engine 423 incorporates any business rules that need to be applied when retrieving, formatting, and sending requested data to the external aggregator 401.

A response processor 424 packages information received from the application server(s) into an XML format that is understood by the external aggregator 401. For example, the response processor 424 maps data objects from an application server to an XML schema suitable for the external aggregator 401. Therefore, the response processor 424 enables responses to be customized to different XML format of different external aggregators. Optionally, if the Request includes requests for information from different application servers, the response processor 424 packages the responses received from the different application servers into one composite XML response.

Once the asynchronous requests are fulfilled, a batch response 421 to the requests is transferred to a proxy server 420. The external aggregator 401 checks the proxy server 420 and retrieves the batch response 421 when available using SOAP procedures, for example.

As mentioned above, Requests that are small or simple are handled synchronously, i.e., they are processed one at a time in real time. Synchronous requests are sent from the request distributor 410 to appropriate business adapters 422 for processing. Upon fulfillment, the responses are sent directly to the external aggregator 401 through the Internet 403 by way of the request distributor 410, the request handler 409, the controller servlet 407, and the Web server 402.

The external interface framework 425 functions to provide a communication interface between the external aggregator 401 and the financial institution. The external interface framework 425 establishes a mode of communication or transport between the financial institution and an external entity requesting information, e.g., the external aggregator 401. It is configurable to accept an XML request in any format as long as the XML request is well formed. A description of a “well-formed” XML document may be found at http://www.w3.orq/TR/REC-xml, the disclosure of which is incorporated herein by reference. The external interface framework 425 is configurable to communicate with underlying data sources within the financial institution using several different communication or transport methodologies (e.g., HTTP, HTTPS, Database, MQ, SOAP, TCP/IP, legacy communications over synchronous and asynchronous channels). It is configurable to return data in any XML format desired by the external entity as long as the outgoing XML response document is well formed. The external interface framework 425 allows for maximum resource utilization by resource pooling of the transport methodologies, and is configurable for varying loads.

As mentioned above, the external aggregator 401 and the financial institution communicate via an interface that adheres to the XML convention. This enables the external aggregator 401 and the financial institution to exchange information even if they use incompatible communications systems. For example, the XML document (the Request) sent from the external aggregator 401 includes multiple requests that each use tag to identify the type of information requested, and also uses tags to identify other information. The XML document is processed by the financial institution based on its tags, which have been predefined and therefore have specific meanings to the financial institution.

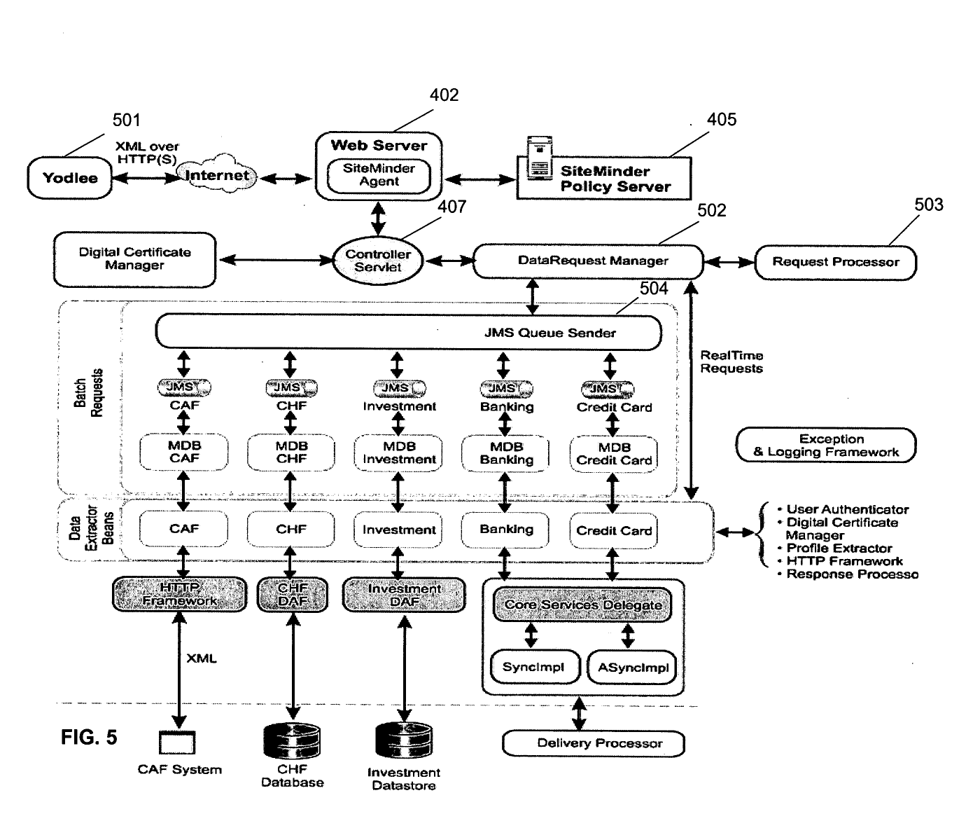

FIG. 5 shows the flow of information according to another embodiment of the present invention. Elements that are similar to those of FIG. 4 are denoted by common reference numerals. In this embodiment, an external Yodlee unit 501 is an external requesting entity corresponding to the external aggregator 401 of FIG. 4; the DataRequest Manager 502 corresponds to the Request Handler 409; and the request processor 503 corresponds to the request distributor 410. The SiteMinder Agent in the Web server 402 is responsible for authenticating the Yodlee unit 501 as a proper requesting entity. The SiteMinder Agent authenticates the external party using a client-side digital certificate. Optionally, the SiteMinder Agent also functions to verify credentials provided with requests for information sent from the Yodlee unit 501. That is, a User Authenticator validates hashed passwords with values stored in a database. This is to ensure that a requester at the Yodlee unit 501 has authentic user credentials for the requested information.

After the Yodlee unit 501 has been authenticated, XML requests for information are redirected to a Controller Servlet 407, which may be hosted on the Web server 402 or hosted on a separate server. The Controller Servlet 407 determines the workflow associated with each request and makes calls to other components based on the state of processing of the request and outputted information obtained from previously called components. The Controller Servlet 407 is managed by configuration parameters of the host server, and thus may be configured to throttle traffic from external parties.

The DataRequest Manager 502 receives authenticated requests and invokes appropriate methods known in the art to retrieve the requested information from components (e.g., application servers) of the system of FIG. 5. The Request Processor 503 parses the XML requests and constructs appropriate RequestData Objects 504. The RequestData Objects 504 are published on an appropriate JMS Queue using a JMS Queue Sender, from where account information MDB (Message Driven Beans) pick them up and hand them over to account-type-specific Data Extractor Beans.

The Data Extractor Beans invoke appropriate methods known in the art on associated or allied components to carry out various business processes, such as authentication, account-number extraction, transaction-summary information retrieval, and conversion of extracted information to an XML response in the required format. In the case of batch requests, the Data Extractor Beans also post the XML response to a URL (Uniform Resource Locator) or address identified by the external Yodlee unit 501.

Requested account information is obtained from application servers corresponding to the requested information. For example, for accessing account information from CRB and CCS data storage units, a messaging framework is used. Investment and CHF account information is retrieved using a Data Access Framework (DAF). CAF account information is accessed through XML documents exchanged over HTTPS via a CAF Web site.

After the requested account information has been retrieved, a Response Processor forms a response XML file to be returned to the external Yodlee unit 501. The Response Processor may be implemented as a generic component to cater to any XML format for the response XML file. For batch updates or responses, the response XML files are posted via a proxy server to a URL identified by the external Yodlee unit 501. Response files are created per user per account type and are posted as an HTTPS request in an asynchronous mode. For example, one XML file will contain all accounts under an account type of one user.

While the present invention has been described with respect to what is presently considered to be the preferred embodiments, it is to be understood that the invention is not limited to the disclosed embodiments. To the contrary, the invention is intended to cover various modifications and equivalent arrangements included within the spirit and scope of the appended claims. The scope of the following claims is to be accorded the broadest interpretation so as to encompass all such modifications and equivalent structures and functions.

1. A System for communicating information, comprising:
an agent module configured to receive from an external party requests for information, wherein the requests for information include at least two verifications from the external party, wherein the verifications comprise (i) a digital certificate corresponding to the external party and (ii) separate credential information for each type of information requested;
a security module configured to authenticate the digital certificate and to verify the credential information;
a controller module configured to throttle an amount of traffic to prevent the request for information from the external party from putting an excessive load on the system;
a request handler module configured to handle the requests for information and to package information from the external party into objects suitable for processing by the system;
a request distributor module configured to determine whether a request for information is to be handled synchronously or asynchronously;
a queue module configured to manage requests to be handled asynchronously by inserting each request in a processing queue corresponding to a type of information requested;
a business adapters module configured to, upon receipt of a request for information from the queue module or from the request distributor module, translate the request for information into a format suitable to be processed by an application server corresponding to the request for information; and
at least one data storage unit configured to store information.

2. A system according to claim 1, wherein the request handler is configured to handle XML requests for information from the external party and to determine in which data storage unit the information requested by the external party is stored.

3. A system according to claim 1,
wherein the security module is configured to authenticate the digital certificate once for a plurality of requests for information from the external party, and
wherein, for each type of information requested, the corresponding credential information provided by the external party is verified based on credential information stored for that type of information.

4. A system according to claim 1, wherein the request distributor makes a determination based on predefined rules, such that simple requests are to be handled synchronously and complex requests are to be handled asynchronously.

5. A system according to claim 4, wherein a simple request is a request for an amount of information less than a predetermined amount.

6. A system according to claim 4, wherein a complex request is a request for multiple types of information.

7. A system according to claim 1,
wherein the business adapters module includes a plurality of business adapters,
wherein the plurality of business adapters corresponds to a respective plurality of subsystems of the system,
wherein each business adapter encapsulates a workflow procedure for obtaining data or information from a corresponding subsystem of the system, and
wherein the business adapters module is expandable to accommodate a new business adapter corresponding to a new subsystem of the system.

8. A system according to claim 1, further comprising a business rules module configured to provide rules for handling the requests for information, wherein the business rules module determines whether requested information is a type of information not to be provided to the external party.

9. A system according to claim 1, wherein the business rules module provides rules for at least one of retrieving, formatting, and sending requested information to the external party.

10. A system according to claim 1, further comprising a response processor module configured to package information received from one or more application servers into a format suitable for the external party.

11. A system according to claim 10, wherein the response processor module packages information into an XML format suitable for the external party.

12. A system according to claim 1, further comprising an external framework module configured to establish a transport mode from a plurality of transport modes for transferring information between the system and the external entity, wherein the transport mode is a HTTP, a HTTPS, a Database, a MQ, a SOAP, a TCP/IP, or a legacy transport mode.

13. A system according to claim 1, wherein at least one of the modules comprising the system is a software routine residing in a server.

14. A method for communicating information between a system and an external party, comprising the steps of:
receiving from the external party requests for information, wherein the requests for information include at least two verifications from the external party, wherein the verifications comprise (i) a digital certificate corresponding to the external party and (ii) separate credential information for each type of information requested;
authenticating the digital certificate to determine whether the external party is authorized to obtain information from the system;
verifying, for each type of information requested, whether the corresponding credential information is valid for that type of information requested;
controlling an amount of traffic to prevent the request for information from the external party from putting an excessive load on the system;
packaging information from the external party into objects suitable for processing by the system;
determining whether a request for information is to be handled synchronously or asynchronously;
for requests to be handled asynchronously, inserting each request in a processing queue corresponding to a type of information requested; and
translating each request for information into a format suitable to be processed by an application server corresponding to the request for information.

15. A method according to claim 14, wherein the requests for information are XML requests.

16. A method according to claim 14,
wherein the step of authenticating authenticates the digital certificate once for a plurality of requests for information from the external party, and
wherein, for each type of information requested, the corresponding credential information provided by the external party is verified based on credential information stored for that type of information.

17. A method according to claim 14, wherein the step of determining is performed based on predefined rules, such that simple requests are to be handled synchronously and complex requests are to be handled asynchronously.

18. A method according to claim 17, wherein a simple request is a request for an amount of information less than a predetermined amount.

19. A method according to claim 17, wherein a complex request is a request for multiple types of information.

20. A method according to claim 14,
wherein the step of translating is performed by a business adapter module that includes a plurality of business adapters,
wherein the plurality of business adapters corresponds to a respective plurality of subsystems of the system,
wherein each business adapter encapsulates a workflow procedure for obtaining data or information from a corresponding subsystem of the system, and
wherein the business adapters module is expandable to accommodate a new business adapter corresponding to a new subsystem of the system.

21. A method according to claim 14, further comprising the step of providing rules for handling the requests for information and determining whether requested information is a type of information not to be provided to the external party.

22. A method according to claim 21, wherein the step of providing rules provides rules for at least one of retrieving, formatting, and sending requested information to the external party.

23. A method according to claim 14, further comprising the step of packaging information received from one or more application servers into a format suitable for the external party.

24. A method according to claim 23, wherein the step of packaging information packages information into an XML format suitable for the external party.

25. A method according to claim 14, further comprising the step of establishing a transport mode from a plurality of transport modes for transferring information between the system and the external entity, wherein the transport mode is a HTTP, a HTTPS, a Database, a MQ, a SOAP, a TCP/IP, or a legacy transport mode.

26. A method according to claim 14, wherein at least one of the steps of comprising the method is performed by a software routine residing in a server.

27. A method according to claim 17, wherein a response to a complex request is forwarded to a proxy server from where the response is may be retrieved by the external party.

28. A system according to claim 1, wherein, if credential information for a type of information cannot be verified although credential information for another type of information can be verified, the business adapters module translates a request for information corresponding to the other type of information.

29. A method according to claim 14, wherein, if credential information for a type of information cannot be verified although credential information for another type of information can be verified, the step of translating translates a request for information corresponding to the other type of information.

30. A system according to claim 4, wherein a response to a complex request is forwarded to a proxy server from where the response is may be retrieved by the external party.

31. A computer-readable storage medium storing computer code for implementing a method of communicating information between a system and an external party, wherein the computer code comprises:
an agent module configured to receive from an external party requests for information, wherein the requests for information include at least two verifications from the external party, wherein the verifications comprise (i) a digital certificate corresponding to the external party and (ii) separate credential information for each type of information requested;
a security module configured to authenticate the digital certificate and to verify the credential information;
a controller module configured to throttle an amount of traffic to prevent the request for information from the external party from putting an excessive load on the system;
a request handler module configured to handle the requests for information and to package information from the external party into objects suitable for processing by the system;
a request distributor module configured to determine whether a request for information is to be handled synchronously or asynchronously;
a queue module configured to manage requests to be handled asynchronously by inserting each request in a processing queue corresponding to a type of information requested; and
a business adapters module configured to, upon receipt of a request for information from the queue module or from the request distributor module, translate the request for information into a format suitable to be processed by an application server corresponding to the request for information.
